(19) United States
(12) Patent Application Publication
(10) Pub. No.: US 2024/0198530 A1
(43) Pub. Date: Jun. 20, 2024

(54) HIGH-LEVEL SENSOR FUSION AND MULTI-CRITERIA DECISION MAKING FOR AUTONOMOUS BIN PICKING

(71) Applicant: Siemens Corporation, Washington, DC (US)

(72) Inventors: Ines Ugalde Diaz, Redwood City, CA (US); Eugen Solowjow, Berkeley, CA (US); Juan L. Aparicio Ojea, Moraga, CA (US); Martin Sehr, Kensington, CA (US); Heiko Claussen, Wayland, MA (US)

(73) Assignee: Siemens Corporation, Washington, DC (US)

(21) Appl. No.: 18/557,967

(22) PCT Filed: Jun. 25, 2021
(86) PCT No.: PCT/US2021/039031

§ 371 Date: Oct. 30, 2023

(51) Int. Cl. B25J 9/16; G06T 7/73; G06V 10/764; G06V 10/80; G06V 10/82; G06V 20/50; G06V 20/70

(52) U.S. Cl. CPC B25J 9/1679; B25J 9/1697; G06T 7/73; G06V 10/764; G06V 10/811; G06V 10/82; G06V 20/50; G06V 20/70; G06T 2207/10024; G06T 2207/10028; G06T 2207/20084

(57) ABSTRACT

In described embodiments of method for executing autonomous bin picking, a physical environment comprising a bin containing a plurality of objects is perceived by one or more sensors. Multiple artificial intelligence (AI) modules feed from the sensors to compute grasping alternatives, and in some embodiments, detected objects of interest. Grasping alternatives and their attributes are computed based on the outputs of the AI modules in a high-level sensor fusion (HLSF) module. A multi-criteria decision making (MCDM) module is used to rank the grasping alternatives and select the one that maximizes the application utility while satisfying specified constraints.

### TECHNICAL FIELD

The present disclosure relates generally to the field of robotics for executing automation tasks. Specifically, the described embodiments relate to a technique for executing an autonomous bin picking task based on artificial intelligence (AI).

### BACKGROUND

Artificial intelligence (AI) and robotics are a powerful combination for automating tasks inside and outside of the factory setting. In the realm of robotics, numerous automation tasks have been envisioned and realized by means of AI techniques. For example, there exist state-of-the-art solutions for visual mapping and navigation, object detection, grasping, assembly, etc., often employing machine learning such as deep neural networks or reinforcement learning techniques.

As the complexity of the robotic tasks increases, a combination of AI-enabled solutions is required. One such example is bin picking. Bin picking consists of a robot equipped with sensors and cameras picking objects with random poses from a bin using a robotic end-effector. Objects can be known or unknown, of the same type or mixed. A typical bin picking application consists of a set of requests for collecting a selection of said objects from a pile. At every request, the bin picking algorithm must calculate and decide which grasp the robot executes next. The algorithm may employ object detectors in combination with grasp detectors that use a variety of sensorial input. The challenge resides in combining the output of said detectors, or AI solutions, to decide the next motion for the robot that achieves the overall bin picking task with the highest accuracy and efficiency.

### SUMMARY

Briefly, aspects of the present disclosure utilize high-level sensor fusion and multi-criteria decision making methodologies to select an optimal alternative grasping action in a bin picking application.

According a first aspect of the disclosure, a method of executing autonomous bin picking is provided, that may be particularly suitable when a semantic recognition of objects in the bin is necessary, for example, when an assortment of mixed object-types is present in the bin. The method comprises capturing one or more images of a physical environment comprising a plurality of objects placed in a bin. Based on a captured first image, the method comprises generating a first output by an object detection module localizing one or more objects of interest in the first image. Based on a captured second image, the method comprises generating a second output by a grasp detection module defining a plurality of grasping alternatives that correspond to a plurality of locations in the second image. The method further comprises combining at least the first and second outputs by a high-level sensor fusion module to compute attributes for each of the grasping alternatives, the attributes including functional relationships between the grasping alternatives and detected objects. The method further comprises ranking the grasping alternatives based on the computed attributes by a multi-criteria decision making module to select one of the grasping alternatives for execution. The method further comprises operating a controllable device to selectively grasp an object from the bin by generating executable instructions based on the selected grasping alternative.

According to a second aspect of the disclosure, a method of executing autonomous bin picking is provided, that may be particularly suitable when a semantic recognition of objects in the bin is not necessary, for example, when only objects of the same type are present in the bin. The method comprises capturing one or more images of a physical environment comprising a plurality of objects placed in a bin and sending the captured one or more images as inputs to a plurality of grasp detection modules. Based on a respective input image, the method comprises each grasp detection module generating a respective output defining a plurality of grasping alternatives that correspond to a plurality of locations in the respective input image. The method further comprises combining the outputs of the grasp detection modules by a high-level sensor fusion module to compute attributes for the grasping alternatives. The method further comprises ranking the grasping alternatives based on the computed attributes by a multi-criteria decision making module to select one of the grasping alternatives for execution. The method further comprises operating a controllable device to grasp an object from the bin by generating executable instructions based on the selected grasping alternative.

Other aspects of the present disclosure implement features of the above-described methods in computer program products and autonomous systems.

Additional technical features and benefits may be realized through the techniques of the present disclosure. Embodiments and aspects of the disclosure are described in detail herein and are considered a part of the claimed subject matter. For a better understanding, refer to the detailed description and to the drawings.

### BRIEF DESCRIPTION OF THE DRAWINGS

The foregoing and other aspects of the present disclosure are best understood from the following detailed description when read in connection with the accompanying drawings. To easily identify the discussion of any element or act, the most significant digit or digits in a reference number refer to the figure number in which the element or act is first introduced.

FIG. 1 illustrates an exemplary autonomous system capable of executing a bin picking application.

FIG. 2 is a block diagram illustrating functional blocks for executing autonomous bin picking according to an example embodiment of the disclosure.

FIG. 3 is an example illustration of portion of a coherent representation of a physical environment generated by high-level sensor fusion module according to an embodiment of the disclosure.

FIG. 4 is an example illustration of a matrix used by a multi-criteria decision making module according to an embodiment of the disclosure.

FIG. 5 illustrates a computing environment within which embodiments of the disclosure may be implemented.

### DETAILED DESCRIPTION

Various technologies that pertain to systems and methods will now be described with reference to the drawings, where like reference numerals represent like elements throughout. The drawings discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged apparatus. It is to be understood that functionality that is described as being carried out by certain system elements may be performed by multiple elements. Similarly, for instance, an element may be configured to perform functionality that is described as being carried out by multiple elements. The numerous innovative teachings of the present application will be described with reference to exemplary non-limiting embodiments.

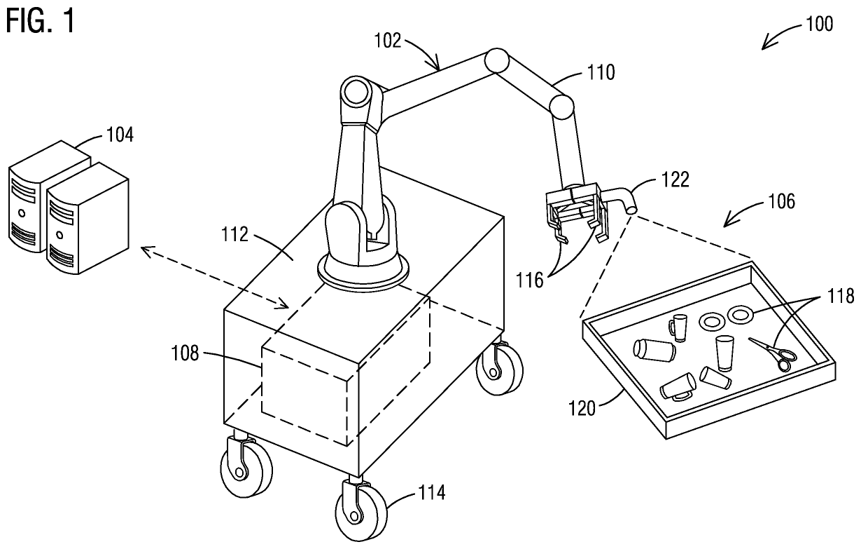

Referring now to FIG. 1, an exemplary autonomous system 100 is illustrated where aspects of the present disclosure may be embodied. The autonomous system 100 may be implemented, for example, in a factory setting. In contrast to conventional automation, autonomy gives each asset on the factory floor the decision-making and self-controlling abilities to act independently in the event of local issues. The autonomous system 100 comprises one or more controllable devices, such as a robot 102. The one or more devices, such as the robot 102, are controllable by a computing system 104 to execute one or more industrial tasks within a physical environment 106. Examples of industrial tasks include assembly, transport, or the like. As used herein, a physical environment can refer to any unknown or dynamic industrial environment. The physical environment 106 defines an environment in which a task is executed by the robot 102, and may include, for example, the robot 102 itself, the design or layout of the cell, workpieces handled by the robot, tools (e.g., fixtures, grippers, etc.), among others.

The computing system 104 may comprise an industrial PC, or any other computing device, such as a desktop or a laptop, or an embedded system, among others. The computing system 104 can include one or more processors configured to process information and/or control various operations associated with the robot 102. In particular, the one or more processors may be configured to execute an application program, such as an engineering tool, for operating the robot 102.

To realize autonomy of the system 100, in one embodiment, the application program may be designed to operate the robot 102 to perform a task in a skill-based programming environment. In contrast to conventional automation, where an engineer is usually involved in programming an entire task from start to finish, typically utilizing low-level code to generate individual commands, in an autonomous system as described herein, a physical device, such as the robot 102, is programmed at a higher level of abstraction using skills instead of individual commands. The skills are derived for higher-level abstract behaviors centered on how the physical environment is to be modified by the programmed physical device. Illustrative examples of skills include a skill to grasp or pick up an object, a skill to place an object, a skill to open a door, a skill to detect an object, and so on.

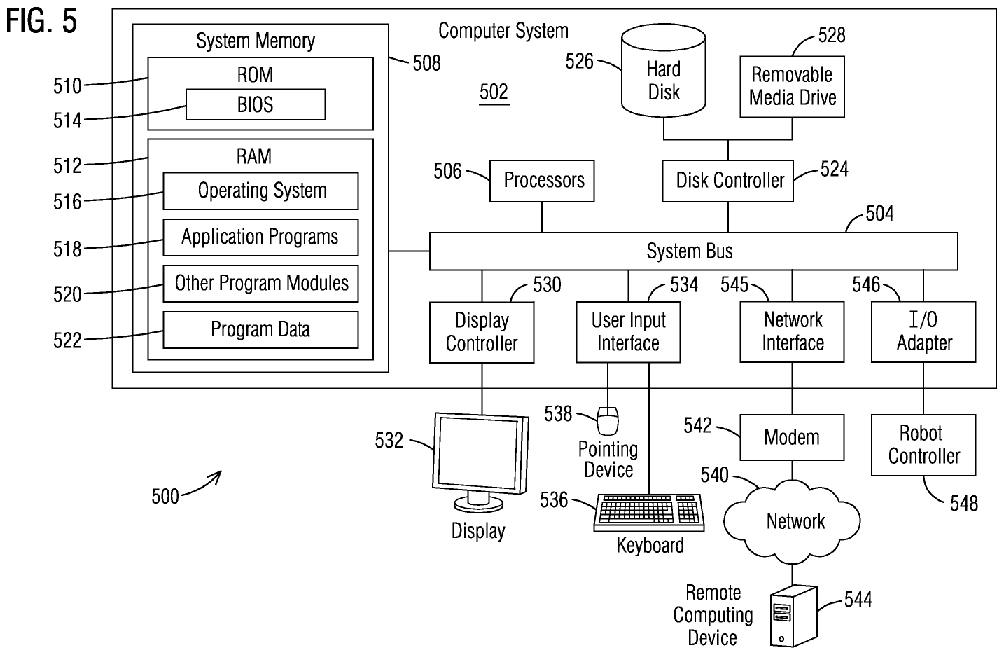

The application program may generate controller code that defines a task at a high level, for example, using skill functions as described above, which may be deployed to a robot controller 108. From the high-level controller code, the robot controller 108 may generate low-level control signals for one or more motors for controlling the movement of the robot 102, such as angular position of the robot arms, swivel angle of the robot base, and so on, to execute the specified task. In other embodiments, the controller code generated by the application program may be deployed to intermediate control equipment, such as programmable logic controllers (PLC), which may then generate low-level control commands for the robot 102 to be controlled. Additionally, the application program may be configured to directly integrate sensor data from physical environment 106 in which the robot 102 operates. To this end, the computing system 104 may comprise a network interface to facilitate transfer of live data between the application program and the physical environment 106. An example of a computing system suitable for the present application is described hereinafter in connection with FIG. 5.

Still referring to FIG. 1, the robot 102 can include a robotic arm or manipulator 110 and a base 112 configured to support the robotic manipulator 110. The base 112 can include wheels 114 or can otherwise be configured to move within the physical environment 106. The robot 102 can further include an end effector 116 attached to the robotic manipulator 110. The end effector 116 can include one or more tools configured to grasp and/or move an object 118. In the shown scenario, the objects 118 are placed in a receiver or “bin.” Example end effectors 116 include finger grippers or vacuum-based grippers. The robotic manipulator 110 can be configured to move so as to change the position of the end effector 116, for example, so as to place or move objects 118 within the physical environment 106. The autonomous system 100 can further include one or more cameras or sensors (typically multiple sensors), one of which is depicted as sensor 122 mounted to the robotic manipulator 110. The sensors, such as sensor 122, are configured to capture images of the physical environment 106 to enable the autonomous system to perceive and navigate the scene.

A bin picking application involves grasping objects 118, in a singulated manner, from the bin 120, by the robotic manipulator 110, using the end effectors 116. The objects 118 may be arranged in arbitrary poses within the bin 120. The objects 118 can be of assorted types, as shown in FIG. 1, or may be of the same type. The physical environment, which includes the objects 118 placed in the bin 120, is perceived via images captured by one or more sensors. The sensors may include, one or more single or multi-modal sensors, for example, RGB sensors, depth sensors, infrared cameras, point cloud sensors, etc., which may be located strategically to collectively obtain a full view of the bin 120. Output from the sensors may be fed to one or more grasp detection algorithms deployed on the computing system 104 to determine an optimal grasp (defined by a selected grasping location) to be executed by the robot 102 based on the specified objective and imposed constraints (e.g., dimensions and location of the bin). For example, when the bin 120 contains an assortment of object types, the bin picking objective may require selectively picking objects 118 of a specified type (for example, pick only “cups”). In this case, in addition to determining an optimal grasp, it is necessary to perform a semantic recognition of the objects 118 in the scene.

Bin picking of assorted or unknown objects may involve a combination an object detection algorithm, to localize an object of interest among the assorted pile, and a grasp detection algorithm to compute grasps given a 3D map of the scene. The object detection and grasp detection algorithms may comprise AI solutions, e.g., neural networks. The state-of-the-art lacks a systematic approach that tackles decision making as a combination of the output of said algorithms.

In current practice, new robotic grasping motions are typically sampled from all possible alternatives via a series of mostly disconnected conditional statements scattered throughout the codebase. These conditional statements check for possible workspace violations, affiliation of grasps to detected objects, combined object detection and grasping accuracy, etc. Overall, this approach lacks the flexibility and scalability required when, for example, another AI solution is added to solve the problem, more constraints are imposed, or more sensorial input is introduced.

Another approach is to combine the grasping and object detection in a single AI solution, e.g. a single neural network. While this approach tackles some of the decision-making uncertainty (e.g. affiliation of grasps to detected objects and combined expected accuracy), it does not allow inclusion of constraints imposed by the environment (e.g., workspace violations). Additionally, training such specific neural networks may not be straight-forward as abundant training data may be required but not available to the extent needed; this is unlike well-vetted generic object and grasp detection algorithms, which use mainstream datasets available through the AI community.

Embodiments of the present disclosure address at least some of the aforementioned technical challenges. The described embodiments utilize high-level sensor fusion (HLSF) and multi-criteria decision making (MCDM) methodologies to select an optimal alternative grasping action based on outputs from multiple detection algorithms in a bin picking application.

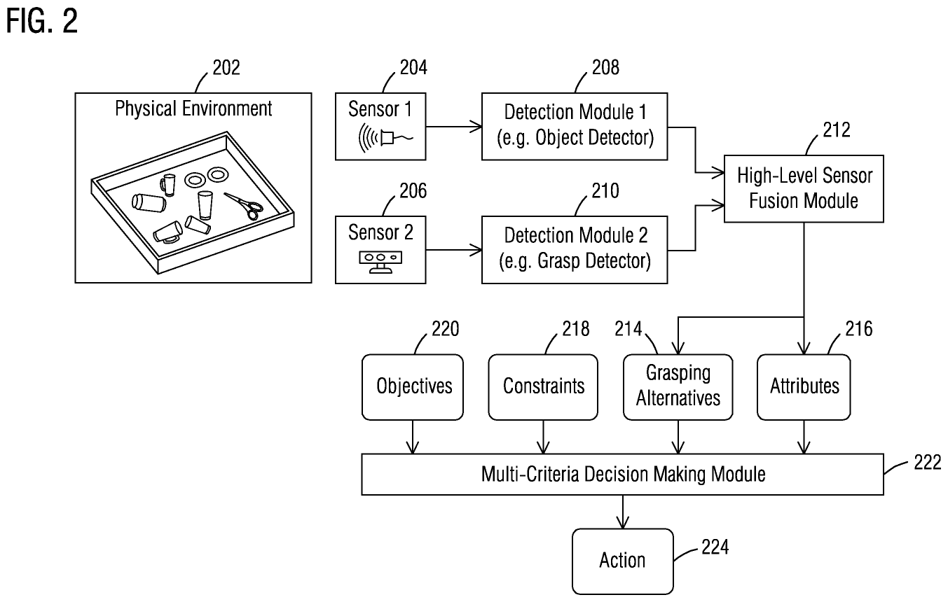

FIG. 2 is a block diagram illustrating functional blocks for executing autonomous bin picking according to described embodiments. The functional blocks may be implemented by an autonomous system such as that shown in FIG. 1. At least some of the functional blocks are represented as modules. The term “module”, as used herein, refers to a software component or part of a computer program that contains one or more routines. In some cases, a module can comprise an AI algorithm, such as a neural network. The modules that make up a computer program can be independent and interchangeable and are each configured to execute one aspect of a desired functionality. In embodiments, the computer program, of which the described modules are a part, includes code for autonomously executing a skill function (i.e., pick up or grasp an object) by a controllable device, such as a robot.

Referring to FIG. 2, the described system includes multiple sensors, such as a first sensor 204 and a second sensor 206, that are configured to capture images of a physical environment 202 comprising objects placed in a bin. In the presently described embodiment, the objects in the bin are of mixed types. The sensors 204, 206 may provide multi-modal sensorial inputs, and/or may be positioned at different locations to capture different views of the physical environment 202 including the bin. The system utilizes multiple detection modules, such as one or more object detection modules 208 and one or more grasp detection modules 210, which feed from different sensorial inputs. In the shown example, a first image captured by the first sensor 204 is sent to an object detection module 208 and a second image captured by the second sensor 206 is sent to a grasp detection module 210. Based on the first image, the object detection module 208 generates a first output locating one or more objects of interest in the first image. Based on the second image, the grasp detection module 210 generates a second output defining a plurality of grasping alternatives that correspond to a plurality of locations in the second image. The terms “first image” and “second image” do not necessarily imply that the first image and the second image are different, and indeed in some embodiments (described later) refer to the same image captured by a single sensor. An HLSF module 212 combines the multiple outputs from the multiple detection modules, such as the above-described first and second outputs, to compute attributes 216 for each of the grasping alternatives 214. The attributes 216 include functional relationships between the grasping alternatives and the located objects. An MCDM module 222 ranks the grasping alternatives 214 based on the computed attributes 216 to select one of the grasping alternatives for execution. The ranking may be generated based on the objectives 220 of the bin picking application (e.g., specific type or types of object to be picked) and constraints 218 that may be imposed by the physical environment (e.g., dimension and location of the bin). In various embodiments, the objectives 220 and/or constraints 218 may be predefined, or may be specified by a user, for example via a Human Machine Interface (HMI) panel. The MCDM module 222 outputs an action 224 defined by the selected grasping alternative, based on which executable instructions are generated to operate the controllable device or robot to selectively grasp an object from the bin.

Exemplary and non-limiting embodiments of the functional blocks will now be described.

Object detection is a problem in computer vision that involves identifying the presence, location, and type of one or more objects in a given image. It is a problem that involves building upon methods for object localization and object classification. Object localization refers to identifying the location of one or more objects in an image and drawing a contour or a bounding box around their extent. Object classification involves predicting the class of an object in an image. Object detection combines these two tasks and localizes and classifies one or more objects in an image.

Many of the known object detection algorithms work in the RGB (red-green-blue) color space. Accordingly, the first image sent to the object detection module 208 may define an RGB color image. Alternately, the first image may comprise a point cloud with color information for each point in the point cloud (in addition to coordinates in 3D space).

In one embodiment, the object detection module 208 comprises a neural network, such as a segmentation neural network. An example of a neural network architecture suitable for the present purpose is a mask region-based convolutional neural network (Mask R-CNN). Segmentation neural networks provide pixel-wise object recognition outputs. The segmentation output may present contours of arbitrary shapes as the labeling granularity is done at a pixel level. The object detection neural network is trained on a dataset including images of objects and classification labels for the objects. Once trained, the object detection neural network is configured to receive an input image (i.e., the first image from the first sensor 204) and therein predict contours segmenting identified objects and class labels for each identified object.

Another example of an object detection module suitable for the present purpose comprises a family of object recognition models known as YOLO (“You Look Only Once”), which outputs bounding boxes (as opposed to arbitrarily shaped contours) representing identified objects and predicted class labels for each bounding box (object). Still other examples include non-AI based conventional computer vision algorithms, such as Canny Edge Detection algorithms that apply filtering techniques (e.g., a Gaussian filter) to a color image, apply intensity gradients in the image and subsequently determine potential edges and track the edges, to arrive at a suitable contour for an object.

The first output of the object detection neural network may indicate, for each location (e.g., a pixel or other defined region) in the first image, a predicted probabilistic value or confidence level of the presence of an object of a defined class label.

The grasp detection module 210 may comprise a grasp neural network to compute the grasp for a robot to pick up an object. Grasp neural networks are often convolutional, such that the networks can label each location (e.g., a pixel or other defined region) of an input image with some type of grasp affordance metric, referred to as grasp score. The grasp score is indicative of a quality of grasp at the location defined by the pixel (or other defined region), which typically represents a confidence level for carrying out a successful grasp (e.g., without dropping the object). A grasp neural network may be trained on a dataset comprising 3D depth maps of objects or scenes and class labels that include grasp scores for a given type of end effector (e.g., finger grippers, vacuum-based grippers, etc.).

In one embodiment, the second image sent to the grasp detection module 210 may define a depth image of the scene. A depth image is an image or image channel that contains information relating to the distance of the surfaces of scene objects from a viewpoint. Alternately the second image may comprise a point cloud image of the scene, wherein the depth information can be derived from the x, y, and z coordinates of the points in the point cloud. The sensor 206 may thus comprise a depth sensor, a point cloud sensor, or any other type of sensor capable of capturing an image from which a 3D depth map of the scene may be derived.

The second output of the grasp detection module 210 can include one or more classifications or scores associated with the input second image. For example, the second output can include an output vector that includes a plurality of predicted grasp scores associated with various locations (e.g., pixels or other defined regions) in the second image. For example, the output of the grasp neural network may indicate, for each location (e.g., a pixel or other defined region) in the second image, a predicted grasp score. Each location or grasping point represents a grasping alternative which may be used to execute a grasp with a predicted confidence for success. The grasp neural network may thus define, for each grasping alternative, a grasp parametrization that may consist of the location or grasping point (e.g. x, y, and z coordinates) and an approach direction for the grasp, along with a grasp score.

In some embodiments, the object detection module 208 and/or the grasp detection module 210 may comprise off-the-shelf neural networks which have been validated and tested extensively in similar applications. However, the proposed approach extends conceptually to other kinds of AI-based or non-AI based detection modules. The detection modules may take input from the deployed sensors as appropriate. For example, in one embodiment, an RGB camera may be connected to the object detection module 208 while a depth sensor may be connected to the grasp detection module 210. In some embodiments, a single sensor may feed to an object detection module 208 and a grasp detection module 210. In examples, the single sensor can include an RGB-D sensor, or a point cloud sensor, among others. The captured image in this case may contain both color and depth information, which may be respectively utilized by the object detection module 208 and the grasp detection module 210.

While the embodiment illustrated in FIG. 2 shows only a single object detection module 208 and a single grasp detection module 210, the proposed approach provides scalability to add any number detection modules and/or sensors. For example, the system may employ multiple object detection neural networks or multiple instances of the same object detection neural network, that are provided with different first images (e.g., RGB color images) captured by different sensors, to generate multiple first outputs. Likewise, the system may employ multiple grasp neural networks or multiple instances of the same grasp neural network, that are provided with different second images (e.g., depth maps) captured by different sensors, to generate multiple second outputs. Replicating the same neural network and feeding the individual instances with input from multiple different sensors provides added robustness. The multiple different sensors may be associated with different capabilities or accuracies, or different vendors, or different views of the scene, or any combinations of the above.

In the first output(s) generated by the one or more object detection modules 208, each location (pixel or other defined region) is associated with a notion regarding the presence of an object. In the second output(s) generated by the one or more grasp detection modules 210, each location (pixel or other defined region) is representative of a grasping alternative with an associated grasp score, but there is usually no notion as to what pixels (or regions) belong to what objects. The HLSF module 212 fuses outputs from the one or more object detection modules 208 and one or more grasp detection modules 210 to compute attributes for each grasping alternative that indicate what grasping alternatives are affiliated to what objects.

By definition, high-level sensor fusion entails combining decisions or confidence levels coming from multiple algorithm results, as opposed to low-level sensor fusion which combines raw data sources. The HLSF module 212 takes the outputs from the one or more object detection modules 208 and one or more grasp detection modules 210 to compose a coherent representation of the physical environment and therefrom determine available courses of action. This involves automated calibration among the applicable sensors used to produce the algorithm results to align the outputs of the algorithms a common coordinate system.

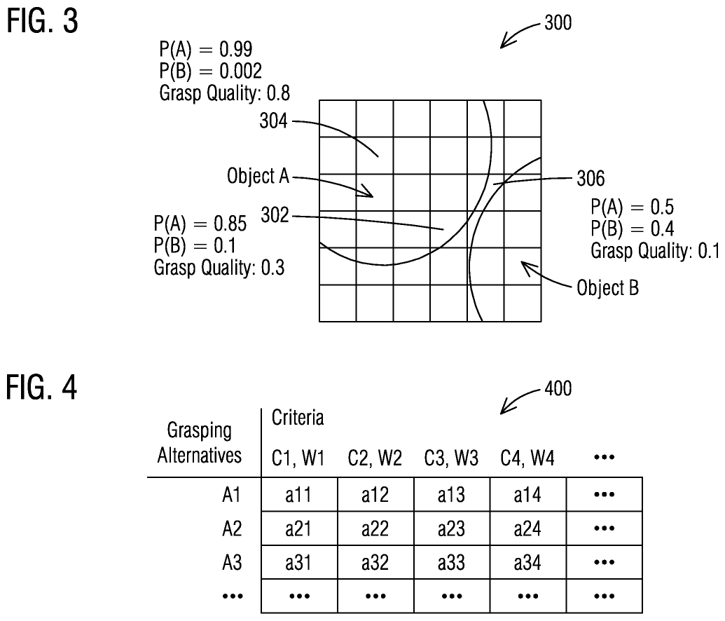

FIG. 3 illustrates a portion of a coherent representation of a physical environment obtained by combining outputs of multiple algorithms. Here, the outputs produced by multiple detection modules 208, 210 are aligned to a common real-world coordinate system to produce a coherent representation 300. The common coordinate system may be arbitrarily selected by the HLSF module 212 or may be specified by a user input. Each location (pixel or other defined region) of the representation 300 holds a probabilistic value or confidence level for the presence an object of interest and a quality of grasp. The above are computed based on a combination of confidence levels obtained from the one or more object detection modules 208 and one or more grasp detection modules 210. Each location of the representation 300 represents a grasping alterative. For example, if multiple grasp detection modules 210 are employed, the quality of grasp for each location (representing a respective grasping alterative) in the coherent representation 300 is computed based on the grasp scores for the corresponding location predicted by the multiple grasp detection modules. As an example, the quality of grasp for a location (pixel or other defined region) in the coherent representation 300 may be determined as an average or weighted average of the grasp scores computed for that location by the individual grasp detection modules. In some embodiments, multiple grasp detection modules 210 may produce similar grasp scores (indicative of quality of grasp) for a particular grasping location (i.e., grasping alternative), but provide very different approach angles for that grasping alternative. This discrepancy in approach angle would result in lower overall score for that grasp. The HLSF module 212 can either lower the quality of that grasping alternative or provide an additional ‘discrepancy’ attribute associated to them. The latter approach may be leveraged by the MCDM module 222 to decide whether to penalize high discrepancy grasping alternatives or to accept them. When multiple object detection modules 208 are employed, the HLSF 212 can compute, for each location (pixel or other defined region) in the coherent representation 300, the probability of the presence of an object of a given class label, for example, using Bayesian inference or similar probabilistic methods. This generalizes to the case where any number of algorithms may be used to produce outputs on the same feature, to achieve redundant information fusion.

Still referring to FIG. 3, three grasping alternatives are illustrated, which correspond to locations or cells 302, 304 and 306 of the coherent representation 300. Each cell of the representation 300 may represent a single pixel or a larger region defined by multiple pixels. The shown portion of the representation includes an object A (i.e., an object of class label A) and an object B (i.e., an object of class label B). The probability of the presence of an object of class label A in a given cell is denoted as P(A). Likewise, probability of the presence of an object of class label B in a given cell is denoted as P(B). The grasping alternatives corresponding to cells 302 and 304 are determined to be affiliated to object A, based on the computed probability P(A). However, the grasping alternative corresponding to cell 304, which is closer to the center of the object A, is associated with a higher quality of grasp than that associated with the grasping alternative corresponding to cell 302. The grasping alternative corresponding to cell 306 has affiliation to multiple objects A and B, based on the computed probabilities P(A) and P(B). In examples, an affiliation of a grasping alterative to a particular object may be determined when the probability P of the presence of that object in the corresponding cell is higher than a threshold value.

The HLSF module thus computes, for each grasping alterative, attributes that include functional relationships between the grasping alternatives and the detected objects. The attributes for each grasping alternative may comprise, for example, quality of grasp, affiliation to object A, affiliation to object B, discrepancy in approach angles, and so on.

Referring again to FIG. 2, based on the grasping alternatives 214 and the respective attributes 216 computed by the HLSF module 212, a decision is made by the MCDM module (222) to select one of the grasping alternatives for execution. As per described embodiments, the MCDM module 222 may rank the grasping alternatives 214 based on multiple criteria that are mapped to the attributes and a respective weight assigned to each criterion. The weights may be determined based on a specified bin picking application objective and one or more specified application constraints.

The MCDM module 222 may start by setting up a decision matrix as shown in FIG. 4. In the shown decision matrix 400, the rows represent possible grasping alternatives A1, A2, A3, etc., while the columns represent criteria C1, C2, C3, C4, etc. The criteria are given by attributes of the grasps. Each criterion C1, C2, C3, C4, etc. is associated with a respective weight W1, W2, W3, W4 etc. Criteria examples include ‘affiliation to object A’, ‘affiliation to object B’, predicted grasp quality, robotic path distance, etc. For each grasping alternative, the weighted score pertaining to multiple criteria is computed by the MCDM module 222. In FIG. 4, the scores for grasping alternative A1 that pertain to criteria C1, C2, C3 and C4 are respectively indicated as a11, a12, a13 and a14 respectively; the scores for grasping alternative A2 that pertain to criteria C1, C2, C3 and C4 are respectively indicated as a21, a22, a23 and a24; and so on. The MCDM module 222 then ranks the grasping alternatives based on the weighted scores on multiple criteria and selects the optimal grasping alternative given a current application objective (e.g., grasp objects of class A and class C only, preference to pick objects with the smallest robotic path distance, preference to pick objects with high quality of grasp even in spite of long travel distances, etc.) and application constraints (e.g., workspace boundaries, hardware of the robot, grasping modality such as suction, pinching, etc.). For this purpose, starting from the decision matrix shown in FIG. 4, one or more of several MCDM techniques may be used to arrive at the final decision. Examples of known MCDM techniques suitable for the present purpose include simple techniques such as Weight Sum Model (WSM) and Weighted Product Model (WPM), or sophisticated techniques such as Analytic Hierarchy Process (AHP) as well as the ELECTRE and TOPSIS methods.

In some embodiments, infeasible grasping alternatives as per the bin picking application may be removed from the decision matrix prior to the implementation of the MCDM solution in order to improve computational efficiency. Examples of infeasible grasping alternatives include grasps whose execution can lead to collision, grasps having multiple object affiliations, among others. In different instances, this constraint-based elimination procedure of candidate grasps may be performed in an automated manner at different stages of the process flow in FIG. 2, such as by the individual detection modules, the HLSF module or at the MCDM solution stage.

Continuing with reference to FIG. 2, the MCDM module 222 outputs an action 224 defined by the selected grasping alternative arrived at by any of the techniques mentioned above. Based on the output action 224, executable code is generated, which may be sent to a robot controller to operate the robot to selectively grasp an object from the bin. The selective grasping can include grasping an object of a specified type from a pile of assorted objects in the bin.

The importance weights of the MCDM module 222 can be set manually by an expert based on the bin picking application. For example, the robotic path distance may not be as important as the quality of grasp if the overall grasps per hour should be maximized. In some embodiments, an initial weight may be assigned to each of the criteria of MCDM module (e.g., by an expert), the weights being subsequently adjusted based on feedback from simulation or real-world execution of consecutive instances of the autonomous bin picking. This approach is particular suitable in many bin picking applications where, while some importance weights are clear or binary (e.g., solutions that can lead to collisions should be excluded), others are only known approximately (e.g., path distance ˜0.2 and grasp quality ˜0.3). Therefore, rather than fixing all importance weights a priori, the expert can define ranges and initial values where the parameters are permitted. The MCDM module 222 can then fine-tune the parameters using the experience from either simulation experiments or the real world itself. For example, based on the success criteria of the current action (e.g., overall grasps per hour), the system can probabilistically at random change the settings in the permitted ranges. More specifically, if the robotic path distance p is defined [0.1 0.3] and grasp quality q is defined [0.2 0.4] then after the first iteration with settings p=0.2 and q=0.3 the system may try again with p=0.21 and q=0.29. If the success criteria are more accurately fulfilled with the new settings than the original settings, the new settings are used as the origin for the next optimization step. If this is not the case, then the original setting remains as origin for the next instance of execution of bin picking. In this way, the MCDM module 222 can fine-tune the settings iteratively to optimize a criterion based on the real results from the application at hand.

The proposed methodology of combining HLSF and MCDM methodologies may also be applied to a scenario where semantic recognition of objects in the bin is not necessary. An example of such a scenario is a bin picking application involving only objects of the same type placed in a bin. In this case, there is no requirement for an object detection module. However, the method may utilize multiple grasp detection modules. The multiple grasp detection modules may comprise multiple different neural networks or may comprise multiple instances of the same neural network. The multiple grasp detection modules are each fed with a respective image captured by a different sensor. Each sensor may be configured to define a depth map of the physical environment. Example sensors include depth sensors, RGB-D cameras, point cloud sensors, among others. The multiple different sensors may be associated with different capabilities or accuracies, or different vendors, or different views of the scene, or any combinations of the above. The multiple grasp detection modules produce multiple outputs based on the respective input image, each output defining a plurality of grasping alternatives that correspond to a plurality of locations in the respective input image. The HLSF module, in this case, combines the outputs of the multiple grasp detection modules to compute attributes (e.g., quality of grasp) for the grasping alternatives. The MCDM module ranks the grasping alternatives based on the computed attributes to select one of the grasping alternatives for execution. The MCDM module outputs an action defined by the selected grasping alternative, based on which executable instructions are generated to operate a controllable device such as a robot to grasp an object from the bin.

Similar to the previously described embodiments, the grasp neural networks in the present embodiment may each be trained to produce an output vector that includes a plurality of predicted grasp scores associated with various locations in the respective input image, the grasp scores indicating a quality of grasp at the respective location. For example, the output of a grasp neural network may indicate, for each location (e.g., a pixel or other defined region) in the respective input image, a predicted grasp score. Each location or grasping point represents a grasping alternative which may be used to execute a grasp with a predicted confidence for success. The grasp neural network may define, for each grasping alternative, a grasp parametrization that may consist of the location or grasping point (e.g. x, y, and z coordinates) and an approach direction for the grasp, along with a grasp score. In some embodiments, the grasp neural networks may comprise off-the-shelf neural networks which have been validated and tested in similar applications.

Furthermore, similar to the previously described embodiments, the HLSF module may align the outputs of the multiple grasp detection modules to a common coordinate system to generate a coherent representation of the physical environment, and compute, for each location in the coherent representation, a probabilistic value for a quality of grasp. The quality of grasp for each location (representing a respective grasping alterative) in the coherent representation is computed based on the grasp scores for the corresponding location predicted by the multiple grasp detection modules. As an example, the quality of grasp for a location (pixel or other defined region) in the coherent representation may be determined as an average or weighted average of the grasp scores computed for that location by the individual grasp detection modules. In some embodiments, multiple grasp detection modules may produce similar grasp scores (indicative of quality of grasp) for a particular grasping location (i.e., grasping alternative), but provide very different approach angles for that grasping alternative. This discrepancy in approach angle would result in lower overall score for that grasp. The HLSF module can either lower the quality of that grasping alternative or provide an additional ‘discrepancy’ attribute associated to them. The latter approach may be leveraged by the MCDM module to decide whether to penalize high discrepancy grasping alternatives or to accept them.

The MCDM module may rank the grasping alternatives computed by the HLSF module based on multiple criteria that are mapped to the attributes and a respective weight assigned to each criterion, the weights being determined based on a specified bin picking objective and one or more specified constraints. To that end, the MCDM module may generate a decision tree, as explained referring to FIG. 4, and arrive at a final decision on an executable action using any known MCDM technique mentioned above. In some embodiments, infeasible grasping alternatives as per the bin picking application may be removed from the decision matrix prior to the implementation of the MCDM solution in order to improve computational efficiency. In further embodiments, as described above, the MCDM module may fine-tune the weights by assigning an initial weight to each of the criteria of the multi-criteria decision module and subsequently adjusting the weights based on feedback from simulation or real-world execution of consecutive instances of the autonomous bin picking.

Summarizing, the proposed methodology links high-level sensor fusion and multi-criteria decision making methodologies to produce quick coherent decisions in a bin picking scenario. The proposed methodology provides several technical benefits, a few of which are listed herein. First, the proposed methodology offers scalability, as it makes it possible to add any number of AI solutions and sensors. Next, the proposed methodology provides ease of development, as it obviates the need to create from scratch a combined AI solution and train it with custom data. Furthermore, the proposed methodology provides robustness, as multiple AI solutions can be utilized to cover the same purpose. Additionally, in a further embodiment, an updated version of MCDM is presented with a technique for self-tuning of criteria importance weights via simulation and/or real-world experience.

FIG. 5 illustrates an exemplary computing environment comprising a computing system 502, within which aspects of the present disclosure may be implemented. The computing system 502 may be embodied, for example and without limitation, as an industrial PC for controlling a robot of an autonomous system. Computers and computing environments, such as computing system 502 and computing environment 500, are known to those of skill in the art and thus are described briefly here.

As shown in FIG. 5, the computing system 502 may include a communication mechanism such as a system bus 504 or other communication mechanism for communicating information within the computing system 502. The computing system 502 further includes one or more processors 506 coupled with the system bus 504 for processing the information. The processors 506 may include one or more central processing units (CPUs), graphical processing units (GPUs), or any other processor known in the art.

The computing system 502 also includes a system memory 508 coupled to the system bus 504 for storing information and instructions to be executed by processors 506. The system memory 508 may include computer readable storage media in the form of volatile and/or nonvolatile memory, such as read only memory (ROM) 510 and/or random access memory (RAM) 512. The system memory RAM 512 may include other dynamic storage device(s) (e.g., dynamic RAM, static RAM, and synchronous DRAM). The system memory ROM 510 may include other static storage device(s) (e.g., programmable ROM, erasable PROM, and electrically erasable PROM). In addition, the system memory 508 may be used for storing temporary variables or other intermediate information during the execution of instructions by the processors 506. A basic input/output system 514 (BIOS) containing the basic routines that help to transfer information between elements within computing system 502, such as during start-up, may be stored in system memory ROM 510. System memory RAM 512 may contain data and/or program modules that are immediately accessible to and/or presently being operated on by the processors 506. System memory 508 may additionally include, for example, operating system 516, application programs 518, other program modules 520 and program data 522.

The computing system 502 also includes a disk controller 524 coupled to the system bus 504 to control one or more storage devices for storing information and instructions, such as a magnetic hard disk 526 and a removable media drive 528 (e.g., floppy disk drive, compact disc drive, tape drive, and/or solid state drive). The storage devices may be added to the computing system 502 using an appropriate device interface (e.g., a small computer system interface (SCSI), integrated device electronics (IDE), Universal Serial Bus (USB), or FireWire).

The computing system 502 may also include a display controller 530 coupled to the system bus 504 to control a display 532, such as a cathode ray tube (CRT) or liquid crystal display (LCD), among other, for displaying information to a computer user. The computing system 502 includes a user input interface 534 and one or more input devices, such as a keyboard 536 and a pointing device 538, for interacting with a computer user and providing information to the one or more processors 506. The pointing device 538, for example, may be a mouse, a light pen, a trackball, or a pointing stick for communicating direction information and command selections to the one or more processors 506 and for controlling cursor movement on the display 532. The display 532 may provide a touch screen interface which allows input to supplement or replace the communication of direction information and command selections by the pointing device 538.

The computing system 502 also includes an I/O adapter 546 coupled to the system bus 504 to connect the computing system 502 to a controllable physical device, such as a robot. In the example shown in FIG. 5, the I/O adapter 546 is connected to robot controller 548. In one embodiment, the robot controller 548 includes, for example, one or more motors for controlling linear and/or angular positions of various parts (e.g., arm, base, etc.) of a robot.

The computing system 502 may perform a portion or all of the processing steps of embodiments of the disclosure in response to the one or more processors 506 executing one or more sequences of one or more instructions contained in a memory, such as the system memory 508. Such instructions may be read into the system memory 508 from another computer readable storage medium, such as a magnetic hard disk 526 or a removable media drive 528. The magnetic hard disk 526 may contain one or more datastores and data files used by embodiments of the present disclosure. Datastore contents and data files may be encrypted to improve security. The processors 506 may also be employed in a multi-processing arrangement to execute the one or more sequences of instructions contained in system memory 508. In alternative embodiments, hard-wired circuitry may be used in place of or in combination with software instructions. Thus, embodiments are not limited to any specific combination of hardware circuitry and software.

The computing system 502 may include at least one computer readable storage medium or memory for holding instructions programmed according to embodiments of the disclosure and for containing data structures, tables, records, or other data described herein. The term “computer readable storage medium” as used herein refers to any medium that participates in providing instructions to the one or more processors 506 for execution. A computer readable storage medium may take many forms including, but not limited to, non-transitory, non-volatile media, volatile media, and transmission media. Non-limiting examples of non-volatile media include optical disks, solid state drives, magnetic disks, and magneto-optical disks, such as magnetic hard disk 526 or removable media drive 528. Non-limiting examples of volatile media include dynamic memory, such as system memory 508. Non-limiting examples of transmission media include coaxial cables, copper wire, and fiber optics, including the wires that make up the system bus 504. Transmission media may also take the form of acoustic or light waves, such as those generated during radio wave and infrared data communications.

The computing environment 500 may further include the computing system 502 operating in a networked environment using logical connections to one or more remote computers, such as remote computing device 544. Remote computing device 544 may be a personal computer (laptop or desktop), a mobile device, a server, a router, a network PC, a peer device or other common network node, and typically includes many or all of the elements described above relative to computing system 502. When used in a networking environment, computing system 502 may include a modem 542 for establishing communications over a network 540, such as the Internet. Modem 542 may be connected to system bus 504 via network interface 545, or via another appropriate mechanism.

Network 540 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computing system 502 and other computers (e.g., remote computing device 544). The network 540 may be wired, wireless or a combination thereof. Wired connections may be implemented using Ethernet, Universal Serial Bus (USB), RJ-6, or any other wired connection generally known in the art. Wireless connections may be implemented using Wi-Fi, WiMAX, and Bluetooth, infrared, cellular networks, satellite or any other wireless connection methodology generally known in the art. Additionally, several networks may work alone or in communication with each other to facilitate communication in the network 540.

The embodiments of the present disclosure may be implemented with any combination of hardware and software. In addition, the embodiments of the present disclosure may be included in an article of manufacture (e.g., one or more computer program products) having, for example, a nontransitory computer-readable storage medium. The computer readable storage medium has embodied therein, for instance, computer readable program instructions for providing and facilitating the mechanisms of the embodiments of the present disclosure. The article of manufacture can be included as part of a computer system or sold separately.

The computer readable storage medium can include a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. Computer readable program instructions described herein can be downloaded to respective computing/processing devices from a computer readable storage medium or to an external computer or external storage device via a network, for example, the Internet, a local area network, a wide area network and/or a wireless network.

The system and processes of the figures are not exclusive. Other systems, processes and menus may be derived in accordance with the principles of the disclosure to accomplish the same objectives. Although this disclosure has been described with reference to particular embodiments, it is to be understood that the embodiments and variations shown and described herein are for illustration purposes only. Modifications to the current design may be implemented by those skilled in the art, without departing from the scope of the disclosure.

1. A method for executing autonomous bin picking, comprising:
capturing one or more images of a physical environment comprising a plurality of objects placed in a bin,
based on a captured first image, generating a first output by an object detection module localizing one or more objects of interest in the first image,
based on a captured second image, generating a second output by a grasp detection module defining a plurality of grasping alternatives that correspond to a plurality of locations in the second image,
combining at least the first and second outputs by a high-level sensor fusion (HLSF) module to compute attributes for each of the grasping alternatives, the attributes including functional relationships between the grasping alternatives and detected objects,
ranking the grasping alternatives based on the computed attributes by a multi-criteria decision making (MCDM) module to select one of the grasping alternatives for execution, and
operating a controllable device to selectively grasp an object from the bin by generating executable instructions based on the selected grasping alternative.

2. The method according to claim 1, wherein the first image defines a RGB color image.

3. The method according to claim 1, wherein the second image defines a depth map of the physical environment.

4. The method according to claim 1, wherein the object detection module comprises a first neural network, the first neural network trained to predict, in the first image, contours or bounding boxes representing identified objects and class labels for each identified object.

5. The method according to claim 4, comprising utilizing multiple first neural networks or multiple instances of a single first neural network that are provided with different first images captured by different sensors, to generate multiple first outputs,
wherein the HLSF module combines the multiple first outputs to compute the attributes for each of the grasping alternatives.

6. The method according to claim 1, wherein the grasp detection module comprises a second neural network, the second neural network trained to produce an output vector that includes a plurality of predicted grasp scores associated with various locations in the second image, the grasp scores indicating a quality of grasp at the respective location, each location representative of a grasping alternative.

7. The method according to claim 6, comprising utilizing multiple second neural networks or multiple instances of a single second neural network that are provided with different second images captured by different sensors, to generate multiple second outputs,
wherein the HLSF module combines the multiple second outputs to compute the attributes for each of the grasping alternatives.

8. The method according to claim 1, comprising:
aligning the first and second outputs to a common coordinate system by the HLSF module to generate a coherent representation of the physical environment, and
computing, by the HLSF module, for each location in the coherent representation, a probabilistic value for the presence an object of interest and a quality of grasp.

9. The method according to claim 1, wherein the attributes computed by the HLSF module comprise, for each grasping alternative, a quality of grasp and an affiliation of that grasping alternative to an object of interest.

10. The method according to claim 1, wherein the ranking of the grasping alternatives by the MCDM module is based on multiple criteria that are mapped to the attributes and a respective weight assigned to each criterion, the weights being determined based on a specified bin picking objective and one or more specified constraints.

11. The method according to claim 10, comprising assigning an initial weight to each of the criteria of the multi-criteria decision module and subsequently adjusting the weights based on feedback from simulation or real-world execution of consecutive instances of the autonomous bin picking.

12. A non-transitory computer-readable storage medium including instructions that, when processed by a computing system, configure the computing system to perform the method according to claim 1.

13. An autonomous system comprising:
a controllable device comprising an end effector configured to grasp an object;
one or more sensors, each configured to capture an image of a physical environment comprising a plurality of objects placed in a bin, and
a computing system comprising:
one or more processors; and
a memory storing instructions that, when executed by the one or more processors, cause the autonomous system to:
based on a captured first image, generate a first output by an object detection module localizing one or more objects of interest in the first image,
based on a captured second image, generate a second output by a grasp detection module defining a plurality of grasping alternatives that correspond to a plurality of locations in the second image,
combine at least the first and second outputs by a high-level sensor fusion (HLSF) module to compute attributes for each of the grasping alternatives, the attributes including functional relationships between the grasping alternatives and detected objects,
rank the grasping alternatives based on the computed attributes by a multi-criteria decision making (MCDM) module to select one of the grasping alternatives for execution, and
operate the controllable device to selectively grasp an object from the bin by generating executable instructions based on the selected grasping alternative.

14. A method for executing autonomous bin picking, comprising:
capturing one or more images of a physical environment comprising a plurality of objects placed in a bin,
sending the captured one or more images as inputs to a plurality of grasp detection modules,
based on a respective input image, each grasp detection module generating a respective output defining a plurality of grasping alternatives that correspond to a plurality of locations in the respective input image,
combining the outputs of the grasp detection modules by a high-level sensor fusion (HLSF) module to compute attributes for the grasping alternatives,
ranking the grasping alternatives based on the computed attributes by a multi-criteria decision making (MCDM) module to select one of the grasping alternatives for execution, and
operating a controllable device to grasp an object from the bin by generating executable instructions based on the selected grasping alternative.

15. The method according to claim 14, wherein the multiple grasp detection modules comprise at least one grasp neural network, the grasp neural network trained to produce an output vector that includes a plurality of predicted grasp scores associated with various locations in the respective input image, the grasp scores indicating a quality of grasp at the respective location, each location representative of a grasping alternative.

16. The method according to claim 15, wherein the multiple grasp detection modules comprise multiple instances of a single grasp neural network that are provided with input images captured by different sensors to generate multiple outputs.

17. The method according to claim 14, comprising:
aligning the outputs of the grasp detection modules to a common coordinate system by the HLSF module to generate a coherent representation of the physical environment, and
computing, by the HLSF module, for each location in the coherent representation, a probabilistic value for a quality of grasp.

18. The method according to claim 14, wherein the ranking of the grasping alternatives by the MCDM module is based on multiple criteria that are mapped to the attributes and a respective weight assigned to each criterion, the weights being determined based on a specified bin picking objective and one or more specified constraints.

19. The method according to claim 18, comprising assigning an initial weight to each of the criteria of the multi-criteria decision module and subsequently adjusting the weights based on feedback from simulation or real-world execution of consecutive instances of the autonomous bin picking.

20. A non-transitory computer-readable storage medium including instructions that, when processed by a computing system, configure the computing system to perform the method according to claim 14.
